(19) United States
(12) Patent Application Publication
(10) Pub. No.: US 2012/0240482 A1
(43) Pub. Date: Sep. 27, 2012

(54) Components for a Modular High-Rise Structures And Method For Assembling Same

(75) Inventors: Michael Pitt, Leamington Spa (GB); Anthony Filippini, Lebanon, NJ (US)

(73) Assignee: XSite Modular, Clinton, NJ (US)

(21) Appl. No.: 13/427,643

(22) Filed: Mar. 22, 2012

Related U.S. Application Data
(60) Provisional application No. 61/465,648, filed on Mar. 22, 2011.

(51) Int. Cl. E04H 12/00; B66F 11/00; E04C 3/30; E04G 21/14; E04B 1/19; E04H 12/34

(52) U.S. Cl. 52/122.1; 52/653.1; 52/831; 52/745.03; 52/741.1; 414/800

(57) ABSTRACT

The disclosed technology relates to a high rise modular structure having a truss structure. The truss structure has four corner columns wherein the columns carrying the load of the building. The columns are adapted to have lifting arms for assembling the structure and plugs for snap fitting the modular units into one another. Once assembled, the modular units are tied to one another using a steel plate/blind rivet system. The modular structure is also capable of having an advanced weather protecting system for when the modular structure is on-site and not yet assembled.

### CROSS REFERENCE TO RELATED APPLICATION

This application claims the benefit of U.S. Provisional Application No. 61/465,648 filed Mar. 22, 2011.

### BACKGROUND

Typical modular structures may be designed and built using either a wide beam design and/or a “C” channel design. For example, FIG. 1 shows a common frame 1 used for these modular structures. As shown in FIG. 1, the frame 1 may be assembled by constructing a base 3. The base 3 includes two base girders 5 and three base purlins 7. Six columns 9 are then placed on top of the base 3 of the frame 1 and a metal decking may be placed on the top side of purlins 7 to create a floor. A ceiling constructed with the same area as the base is then supported by a top portion of the columns.

As shown in FIG. 1a, in this type of modular structure, the load path (shown by downward facing arrows) is equally applied across the entire length of the ceiling frame which then applies its weight to each column 9. This load in turn applies the load to the base girders 5. Therefore, during the design phase a builder uses a function that the depth “X” of the girder is a function of span “Y” of the ceiling girder. (See FIGS. 1a and 4b).

This causes the modular structure to have several limitations. First, since the depth of the girders in the base is a function of the length of the modules, the base varies in depth which causes either a volume loss within the interior of the structure or the modular structure must be built taller. If difference in height requires a taller building, it may possibly create an issue with the local codes on height limitations.

Second, to minimize deflection and maintain small cross sections beams, this type of construction requires several columns in predetermined positions. Additionally, diagonal bracing for seismic and wind loads must be used to fortify the conventional structures.

And third, since the load path goes through each of these columns, the modules requires supports 17 to be positioned under the base's girders to line up with the columns.

Once these structures are assembled, these structured need to be moved a minimum of two times. The first movement is to load the structure on a transport vehicle and the second movement is to set the modular structure on its foundation. As shown in FIG. 5, in order to lift the assembled frame 1, lifting points need to be installed on the frame 1 itself. To date, these lifting points were a plate assembly 50 that is bolted with bolts 56 to the frame 1 prior to lifting the module. Once the frame 1 was lifted and loaded on a transport vehicle, the plate assembly 50 was removed because of height restrictions for transportation. Often, these plates 50 are misplaced because of the site activities and are quite expensive to replace. Also, the lifting support strength of the plates 50 is done by the bolts threads. The bolt 56, not the threads, has a tensile strength of 6,600 lbs each and typically there are four per connection. Due to the weight of the structures, these bolts 56 can only be used once. This means the lifting lug 50 is mounted on the module 1 to load on the truck, and then it is removed. When the module 1 arrives on site, the lifting lug 50 is again mounted by using new bolts. Another disadvantage is that the safety is human dependent to make sure the bolt 56 is properly tightened.

Once the modules arrive on-site, setting the modules on the foundation was performed by the eye of the rigger. (See FIG. 8). It was required to use a crow bar and close co-ordination of the crane operator to properly set these structures. For example, a top module 80 may have to be set on a bottom module 82. Therefore, the base 81 of the top module 80 must be aligned with the ceiling 83 of the bottom module 82 and a spacer 84 separating the two modules 80, 82 may be placed in between the base 83 and the ceiling 81. Once set, a weld 86 is made to adhere the two modules 80, 82 together. This is a slow process with many safety issues. Also, it is not extremely accurate and many attempts at setting a structure on their mate lines are made before a proper alignment is reached.

Once properly aligned, the modules are connected to one another. In the past several methods were used to connect one module 80 to the other 82. Most common were welding and bolting. The issue with welding is that equipment has to be transported to the top of the module during the lifting and several people are needed above and below the lift for safety—welder, safety man and fire watchman (due to the insulation and finishing inside the modules). The issue with bolting is that since accuracy in setting the structures is difficult to achieve, it is even harder to align bore holes and insert bolts into these holes. Also, you again must depend on a person to properly tighten the bolts.

Another issue that arises with these modular structures is weather protection. Since modules could be open on several sides and sometimes are not brought to the site until weeks after construction, water, snow, etc. may be allowed to enter the module and cause a great deal of damage. In the past tarps 141 have been used to protect the module 140 from the element (See FIG. 14). These tarps 141 are slipped over the module 140 from the top and are tied down to the base 145 of the module via cables 142. The base 145 of the module 140 needs a special rim 147 welded in place so that a cable 142 can be attached to it. The disadvantage in this design is cost, as it may take several man hours to put the tarps on and off. Also, the tarps are hard to reuse because they are usually custom fit to a particular module, and unless you have all modules the same size they cannot be reused. Additionally, due to the size of these tarps they are difficult to keep clean and refolding for storage is difficult.

### SUMMARY OF THE DISCLOSED TECHNOLOGY

The disclosed technology relates to high rise modular buildings having a truss structure and preferably a Vierendeel Truss structure. The truss structure has four corner columns wherein the columns carrying the load of the building. The columns are adapted to have lifting arms for assembling the structure and plugs for snap fitting the modular units into one another. Once assembled, the modular units are tied to one another using a steel plate/blind rivet system or other known fixing method. The modular structure is also capable of having an advanced weather protecting system for when the modular structure is on-site and not yet assembled.

In one embodiment, a truss for a modular structure comprises a base formed from two base girders and two base purlins with the base including four right angle sections. A ceiling is also formed using two ceiling purlins and two ceiling girders with the ceiling including four right angle sections. Four columns are then attached to the base and ceiling at the right angle sections. That is, the top portions of the columns are attached to the ceiling at the right angle sections and the bottom portion of the columns are attached to the base at the right angle sections. This truss allows a load path to be carried by the four columns so that an effective depth of a beam is the height of the column. In another embodiment the column may be attached directly to the girder thereby eliminating the right angle sections.

In another embodiment, a column for a modular structure comprises a lifting arm expanding a hollow portion of the column. The lifting arm is used for lifting the modular structure. The lifting arm may be a pin that tightly fits into a set of aligned holes on the column. The lifting arm may also be a pin that is formed integral with the column during casting.

In another embodiment, the disclosed technology discloses a method for lifting a modular structure having four hollow corner columns. The method comprises the steps of applying a lifting strap to a lifting arm expanding a hollow portion of each of the four columns and lifting the modular structure.

In another embodiment, a column for a modular structure comprises a top, a bottom and four sides. The column may have a hollow interior and may be attached to a tapered plug at one end. The tapered plug is capable of snap fitting into a hollow interior of a second column. The tapered plug may be round with a taper of approximately 30 degrees or the tapered plug may be oval-shaped so as to prevent rotation of the column during setting.

In another embodiment, the disclosed technology discloses a method for assembling a modular high rise. The method comprises the steps of lifting a first section of the modular high rise, aligning the first section with a second section, setting a set of aligning plugs into receiving columns of the second modular structure and fixing the first section to the second section. The set of plugs may include one snap fit plug, one non-rotating plug and two floating plugs.

In another embodiment, the disclosed technology discloses a method for covering a modular structure during a storage period. The method comprises the steps of covering the modular structure with a light gauge plastic, covering the top of the modular structure with a sheet of rubber base and making a skirt on a bottom portion of the modular structure.

### BRIEF DESCRIPTION OF THE DRAWINGS

FIG. 1 is a prospective view of a conventional modular frame;

FIG. 1a is a side view of a conventional modular frame;

FIG. 2 is a prospective view of a modular frame used in accordance with the disclosed technology;

FIG. 2a is a side view of a modular frame used in accordance with the disclosed technology;

FIG. 2b is an exploded view of a modular frame used in accordance with the disclosed technology;

FIG. 3 is a prospective view of a base of a modular frame used in accordance with the disclosed technology;

FIGS. 3a-b are close-up views of a base of a modular frame used in accordance with the disclosed technology;

FIG. 4a is a side view of a modular frame used in accordance with the disclosed technology;

FIG. 4b is a side view of a conventional modular frame;

FIG. 5 is a prospective view of a lifting lug used with conventional modular frames;

FIGS. 6 and 6a are prospective views of a lifting apparatus used in accordance with the disclosed technology;

FIG. 7 is a top view of a lifting apparatus used in accordance with the disclosed technology;

FIG. 7a is a side view of a lifting apparatus used in accordance with the disclosed technology;

FIG. 8 and FIG. 8a are prospective views of a stacking method used with conventional modular frames;

FIG. 9 is a prospective view of an interlocking modular structure used in accordance with the disclosed technology;

FIG. 9a is a side view of an interlocking modular structure used in accordance with the disclosed technology;

FIG. 9b is a top view of an interlocking modular structure used in accordance with the disclosed technology;

FIG. 9c is a prospective view of an interlocking plug used in accordance with the disclosed technology;

FIG. 10 is a prospective view of an interlocking modular structure used in accordance with the disclosed technology;

FIGS. 11, 12, and 13 are prospective views of a connection method used with conventional modular frames;

FIG. 12a is a top view of a connection method used with conventional modular frames;

FIG. 14 is a prospective view of a wrapping method used with conventional modular frames; and

FIGS. 15, 15a, 16 17 and 18 are prospective views of a wrapping method used in accordance with the disclosed technology.

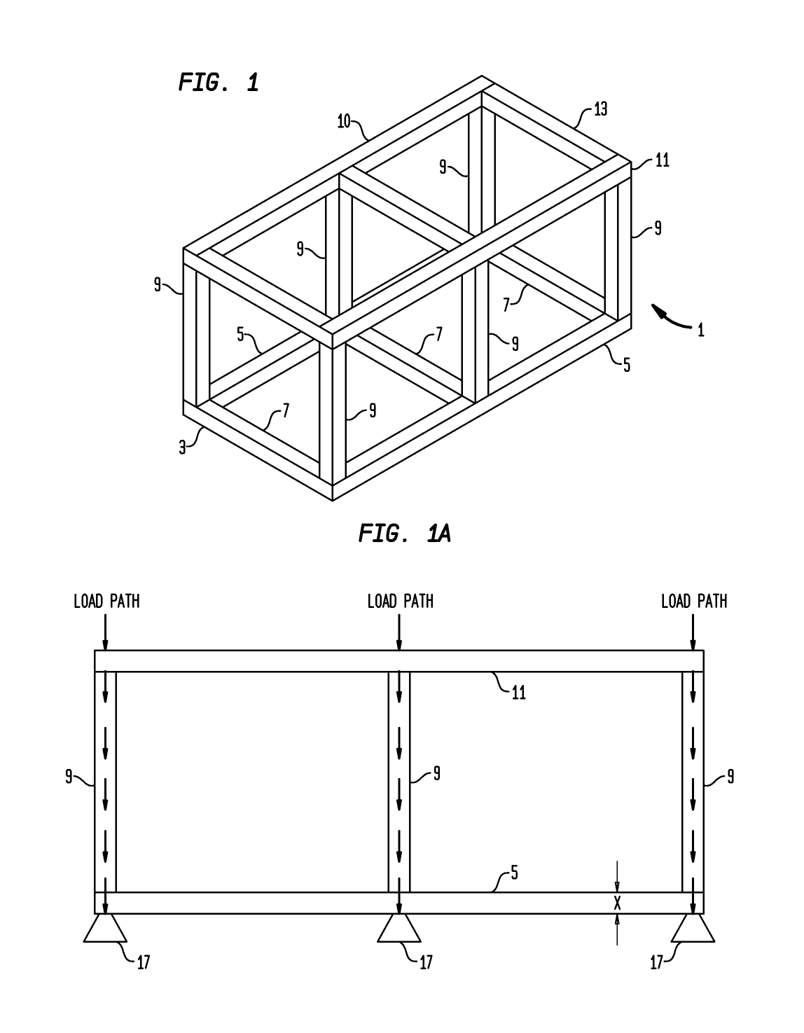

### DETAILED DESCRIPTION

The building of a modular high rise is a difficult task and there are many disadvantages to using typical modular structures as discussed above. The disclosed technology discusses a type of modular structure that eliminates many of the disadvantages of conventional modular structures.

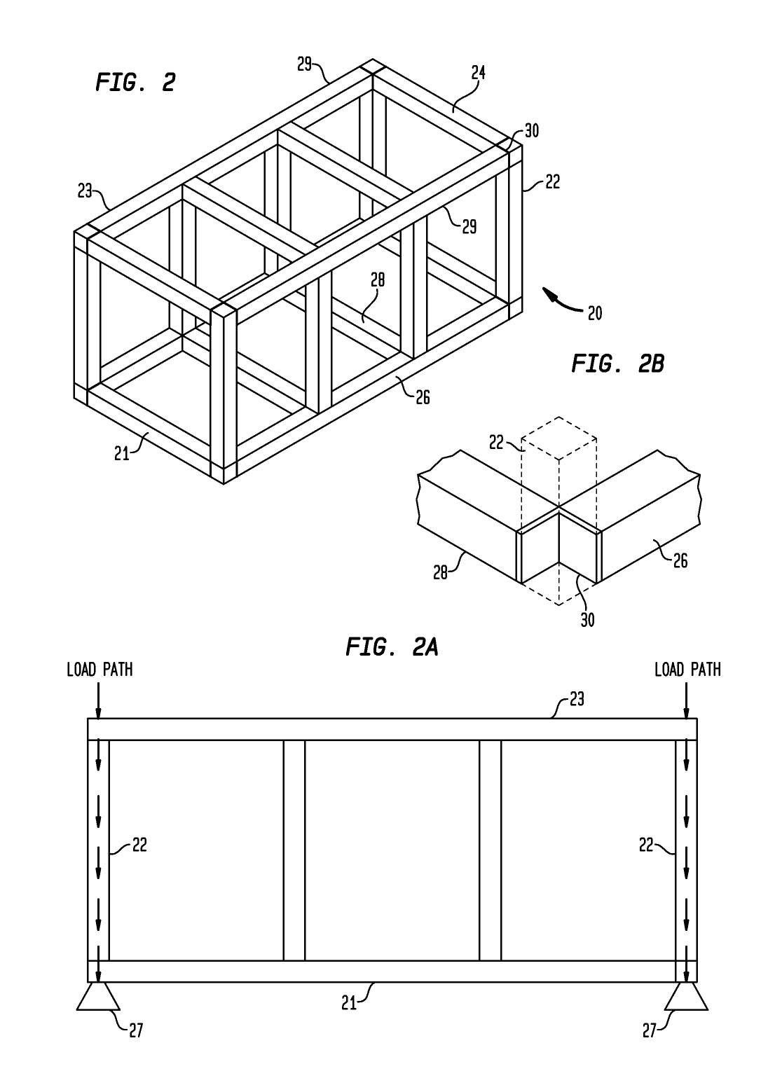

As shown in FIG. 2, a modular frame 20 will be designed using hollow structural sections (“HSS)’ for the girders 26, 29, purlins 24, 28 and columns 22 instead of the conventional “C” or “wide flange” beams. The girders 26, 29, purlins 24, 28 and columns 22 may be pre-casted using a lightweight concrete. This type of HSS is less expensive and lighter than the traditional components.

The structure 20 will use a truss design to achieve a strong and yet simple module. In one embodiment, a Vierendeel Truss may be used. The Vierendeel Truss is an open-web truss with vertical members without diagonals. That is, a Vierendeel Truss is a truss where the members are not triangulated but form rectangular openings and have fixed and/or rigid joints that are capable of transferring and resisting bending moments. Essentially, these girders 26, 29, purlins 24, 28 and columns 22 form a three-dimensional Vierendeel Truss design 20. Diagonal bracing can be omitted as the joints are designed to withstand the moments that occur at the ends of the members. The advantage of using such a truss design is that by eliminating diagonal members, the creation of rectangular openings for windows and doors is simplified. This type of truss construction also reduces or eliminates the need for compensating shear walls.

As shown in FIG. 2a, in order to construct such a truss design, the columns 22 having a height H will begin a bottom edge of base 21 and continue upwards to the top edge of ceiling 23. This design allows the load path to only go through the columns 22 from floor to floor of a high rise structure and not be dependent on the depth of a girder as was the case in the conventional design.

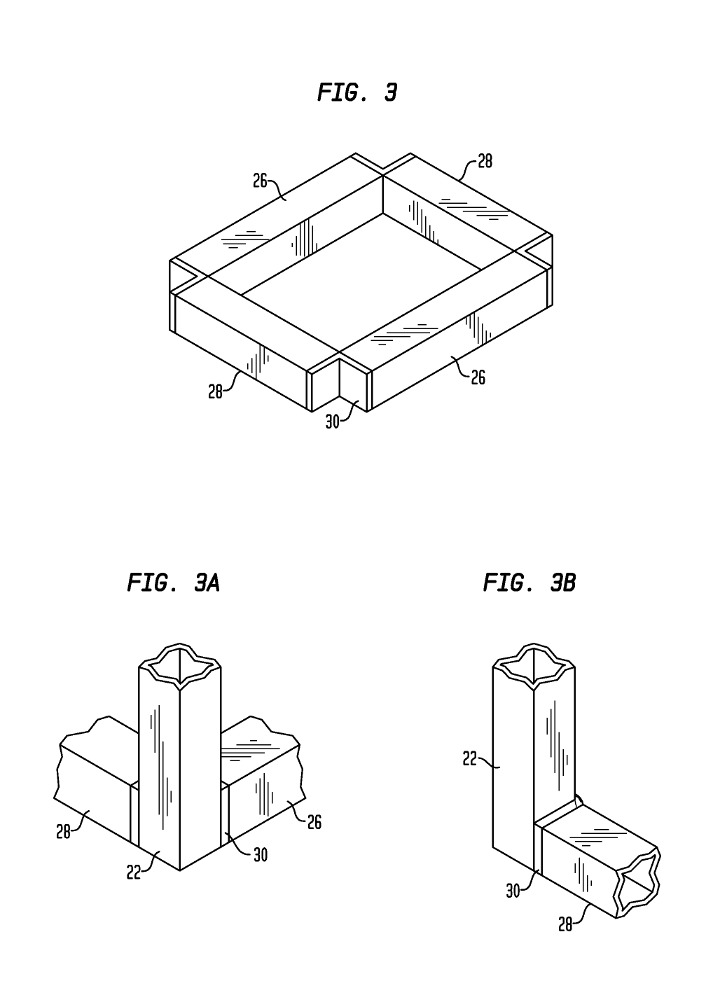

To construct such a truss, a base 21 and a ceiling 23 are formed using steel angle plates 30, as shown in FIGS. 3, 3a and 3b. This design allows the base 21 and ceiling 23 to be built as separate components and allows the columns 22 to be attached to the steel plates at a later time during assembly of the frame 20. Specifically, purlins 28 and girders 26 are welded at their respective ends using a right angle steel plate 30. Once assembled, the ceiling 23 and base 21 can be handled as a single integral piece. During the final assembly phase of the truss, the columns 22 are placed within the space created by the right angle plate 30. The columns 22 are then welded into position for a stronger hold. Supports 27 may be used on the underside of the columns 22 when needed.

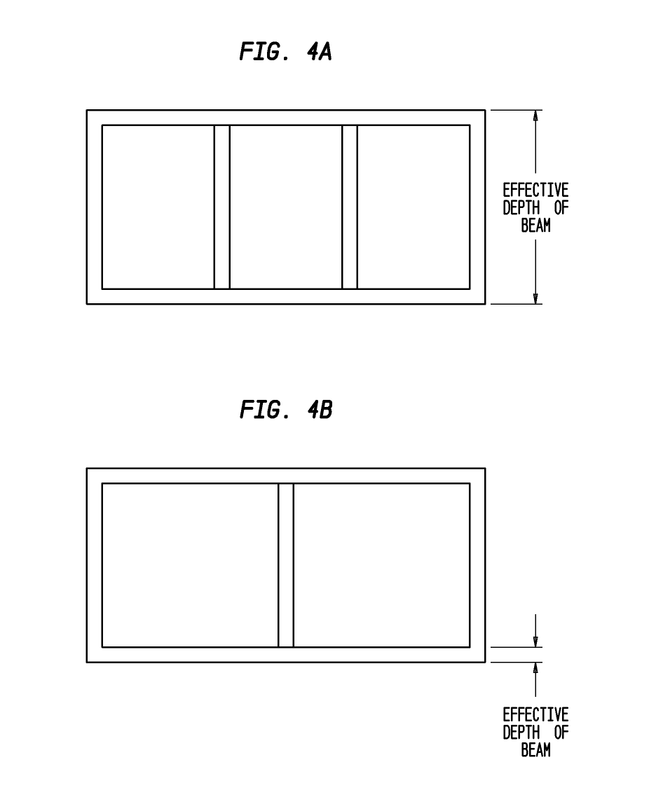

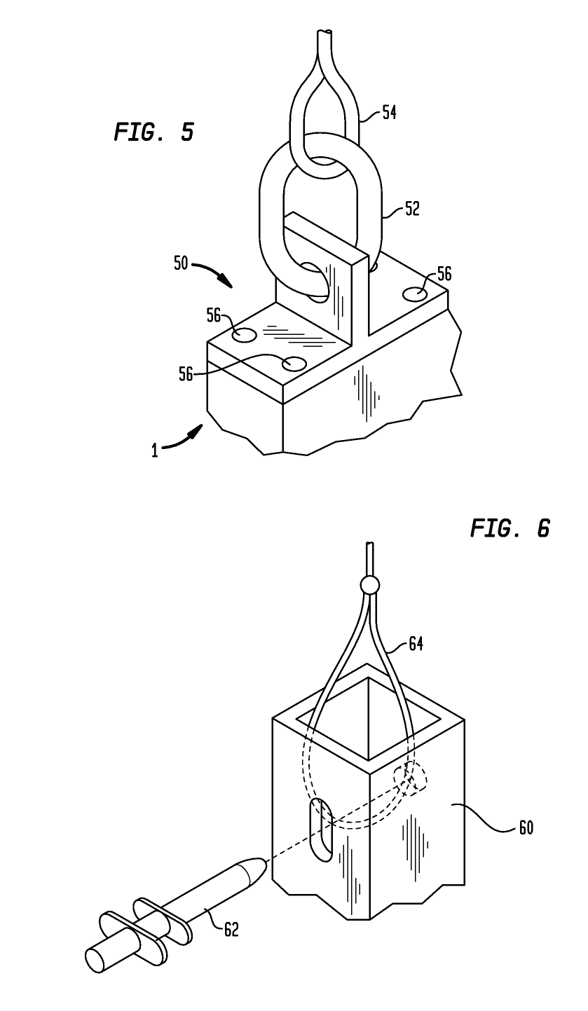

By using this structure the same cross section can be used for each of the girders 26, purlings 24, 28 and columns 22. This holds true for modules of all lengths because the effective length for the load is the height of the column (See FIG. 4a) and not dependent on the height of the bottom girder as in the conventional designs (See FIG. 4b). So different length modules may be constructed, e.g., 20′, 24′, 32′, 40′, 48′ and 56′, without changing the depth of the girders.

In another embodiment, instead of using the right angle plates 30, it is possible to use portal frame construction for building and designing the modular structures. Portal frame construction primarily uses steel or steel-reinforced precast concrete and the connections between the columns and the purlings and girders are designed to be moment-resistant, i.e. they can carry bending forces. Because of these very strong and rigid joints some of the bending moment in the rafters is transferred to the columns. This means that the size of the rafters can be reduced or the span can be increased for the same size rafters. This makes portal frames a very efficient construction technique to use for some modular structures.

Some benefits of the disclosed truss systems may be: (1) Higher resistance to bending moments, (2) Eliminating any additional supports underneath the base, other then at the 4 corner columns, (3) Easier to create a system to fire protect the structure because the columns are the members that load path goes through then these are the only members that need to be individually protected, (4) Lighter module due to the lightweight concrete or potential elimination of concrete and substituted with lighter weight cement bonded particle board or other light weight sheathing. (5) Columns foot print stays the same and only the wall thickness changes as a function of the number of floor or stories and (6) The full height of the frame is the depth of the beam. (See FIG. 4).

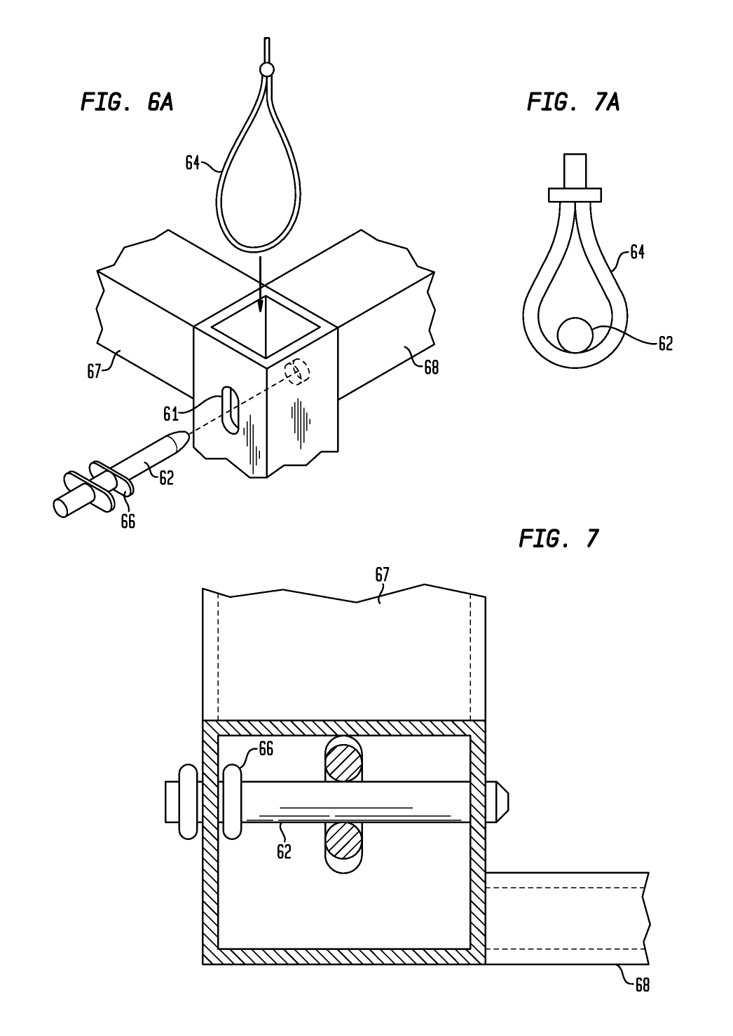

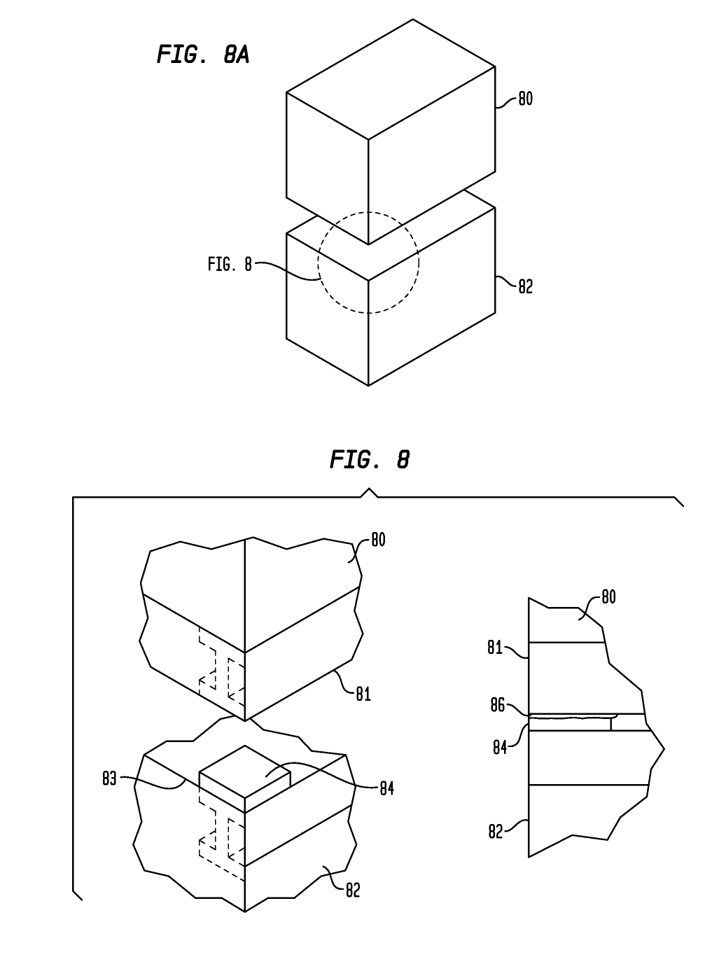

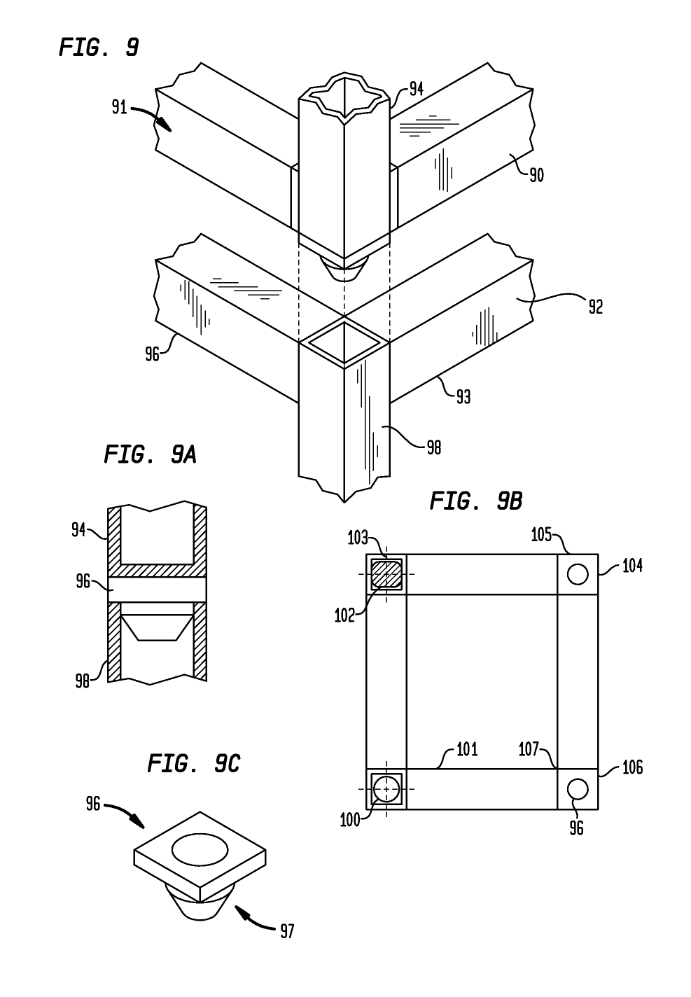

As shown in FIGS. 6 and 7 and discussed above, the modular structure uses hollow columns 60. In a preferred embodiment, there are two holes 61 located in a top portion of the column 60. These holes 61 are aligned with one another so that a lifting pin 62 may be inserted into the openings 61. That is, the pin 62 may be inserted into one opening 61 and pushed through to the other opening 61 so that the pin protrudes from both sides of the column. The pin may have a diameter of ½-3 inches with a pin head of 1-4 inches. Once inserted, the pin may be rotated 90 degrees so that a sleeve 66 located on the pin may be engaged with the column to prevent the pin from slipping out of the slot. In multiple module connections, where access may be a concern, a fixed and integrated pin inside the column assembly may be used.

In use, when lifting the structure, an operator will lower an insert cable 64 to a crew member. The insert cable may be approximately ¾ inch cable. Once received, the crew member will set the pin 62 with the cable 64 being wrapped around the pin 62. A visual signal will then be given to the operator that the pin is properly set. The operator will then lift the structure and after the module has been loaded onto the truck the pin is removed and may be inserted into the rigger belt for the next use. At the building site, when the truck arrives, the pin is then inserted again for lifting the module off the truck to set the module on the foundation. Each pin and HSS column can lift up to 90,000 lbs, which is 3 to 4 times stronger than the conventional 4 bolt method. In another embodiment, a lifting arm may permanently be attached to the interior of the hollow column during casting. This arm will have the same effectiveness as the lifting pin but will not be removable. The lifting strap may then be wrapped around this lifting arm for lifting.

The benefits of the lift system include (1) a safer lift and eliminates the human factor of attaching a conventional support plate to the structure, (2) simpler and can be made out of cast, (3) small enough to fit into a rigger's belt, (4) lower in cost and (5) higher picking capacity 90,000 lbs.

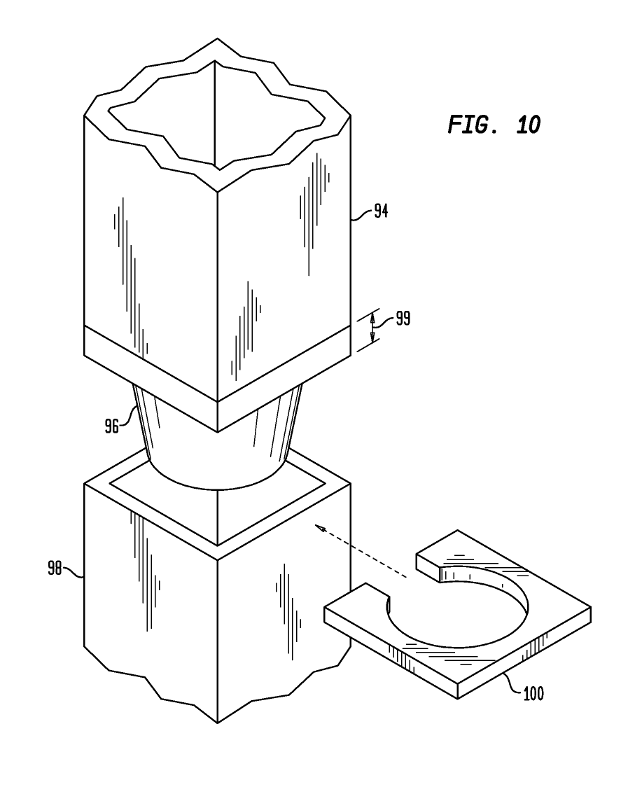

When setting the structures onto the foundation or on top of one another, the conventional method of using site lines for stacking was inefficient. FIG. 9 shows a method for stacking that is more accurate and faster. That is, the modules 91 and 93 can be snapped fitted together. To achieve these ends, at the bottom of each column 94 there may be an interlock pin/plug 96. These pin/plugs 96 compensate for any misalignment of approx. 2″ and snap into place with the lower modules.

In use, each modular structure comes equipped with a four pin/plug system. Two of the four pin/plugs are tapered and allow for a small margin of error when setting the modules in place. As shown in FIG. 9b, a first column 101 may have a slip fit pin 103. This slip fit pin 103 is the first pin to be aligned with the bottom module 93. As shown in FIG. 9c, the slip pin 96 is round and has a 30 degree taper (30 degrees is the best mode but the taper can be in a range from 15-60 degrees depending on multiple factors of alignment parameters). This taper allows for some degree of misalignment. The second pin 102 in the second column 103 to be set is a diamond pin 102. The diamond pin 102 may also be tapered but has an oval-like or diamond design to prevent rotation with respect to the modules. This diamond pin is usually the second pin to make contact when setting the modules. The third and fourth pins 104 and 105 are not needed for misalignment and are floating pins that enter the bottom column. All of the pins have the same height so when the modules are being stored the structure is level. Additionally, the pin/plugs may also include a spacer portion 99 that may ½ to 3 inches in height.

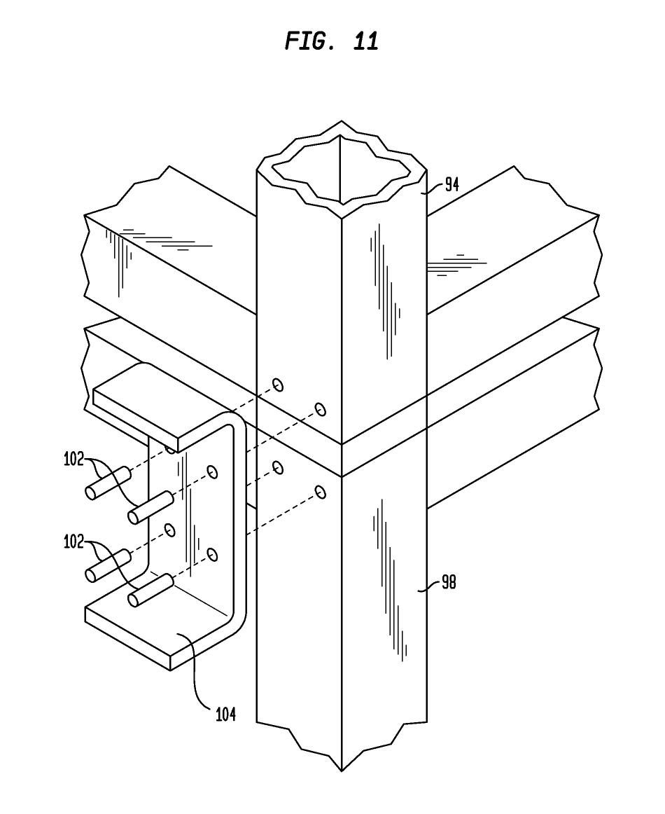

Due to the four pin system, the difficulty between the crane operator and the setting team has been greatly simplified. Further explanation is as follows: when a crane operator wants to set a modular structure, the crane operator needs only to get relatively close to a setting point. When close, a setting team will allow the crane operator to set Column #1 first. Column #1 has a plug 101 that tightly slip fits into the column of the lower module 93 and allows for some misalignment. After Col #1 is in place, the crane operator and setting team will position Col #2. Column #2 has what is called a diamond plug 103 that allows misalignment lengthwise but prevents rotation about the tightly slip fit pin/plug in column #1. Once Col #1 and #2 are in position pins Cols. #3 and #4 are set. Column #3 and #4 have a plug that fits loosely into the column below so that they have no effect with column #1 and #2. The four pin/plugs are all of the same length so that when the module sits on a ground surface in the staging area is level with ground and will allow any water, from rain, to run underneath the module without affecting the module. Another feature, shown in FIG. 10, is a shim 100. If the module needs to be leveled the shim 100 is a simple method to do so. The shim must be made from a material that will not compress when a great weight is applied.

Benefits of this alignment system are substantial, e.g., the system provides more accurate assembly and eliminates visual alignment, it reduces the labor time to assemble the modules, it is safer because there is no need for the rigger to stand on the ceiling of the lower module, it allows for rain water to go underneath the modules when they are sitting on the ground in the staging area and eliminates the use of crow bars to push modules into place.

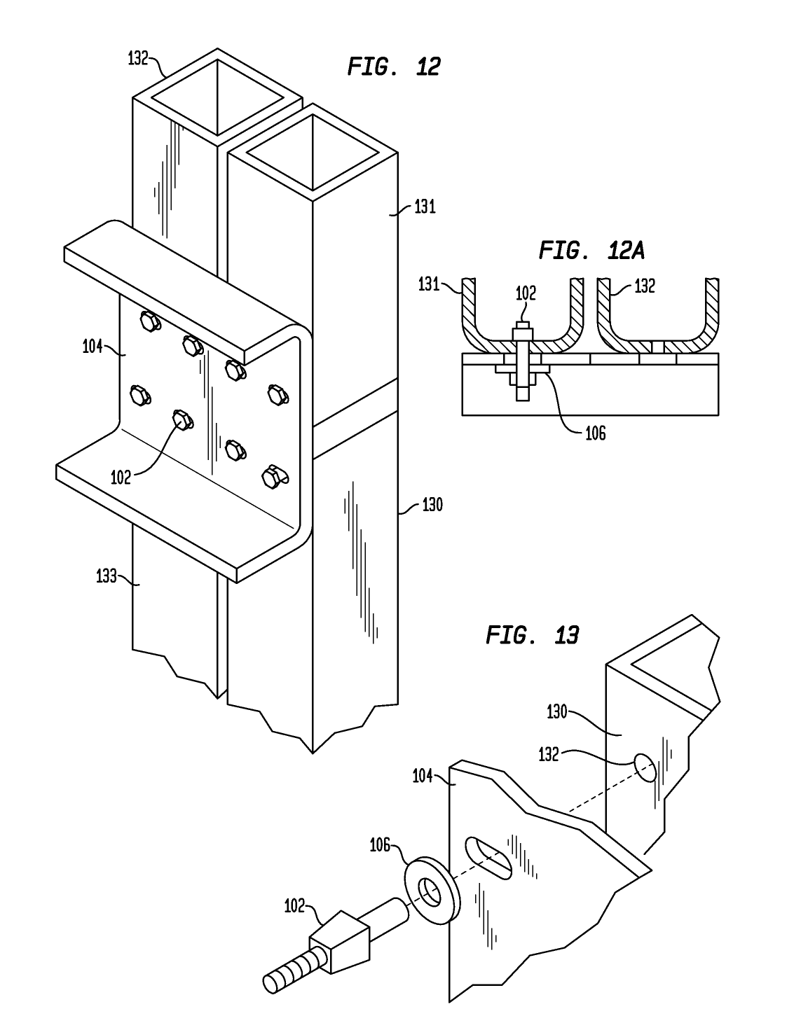

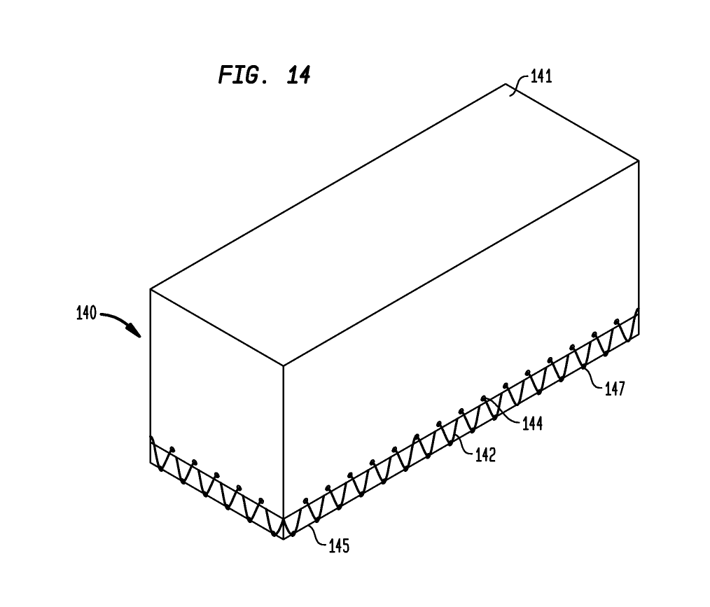

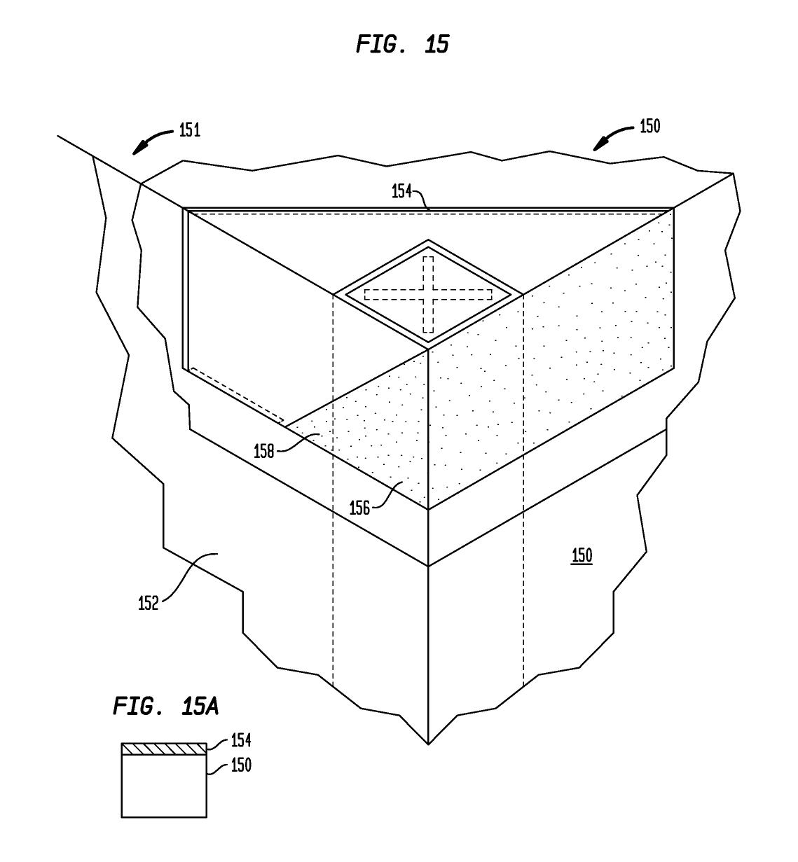

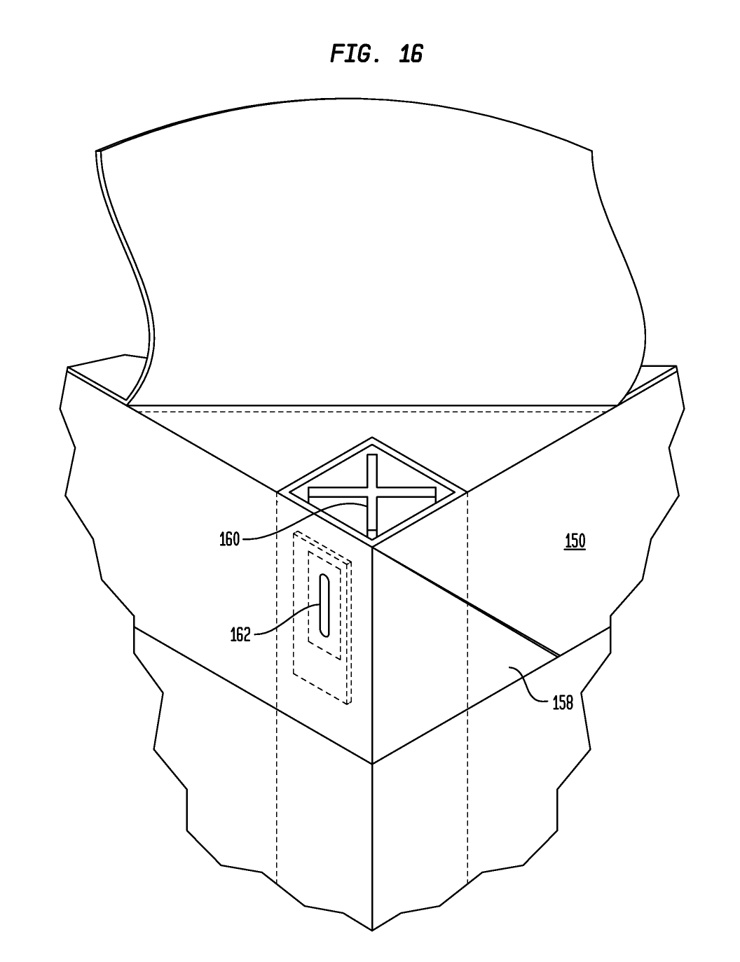

Once the modular structures are set in place, the structures can be tied to one another for strength. As shown in FIGS. 11-13, in order to ensure a tight hold, a plate 104 (e.g. a steel plate) and a blind rivet 102 (e.g. ⅜″ rivet) may be used. The plate 104 may have a rivet slot (e.g., 0.390″×¾″ slot) that compensates for misalignment between a neighboring structure. This plate may or may not have side channels. On the side of the slot a hardened steel washer 106 (e.g., a ¼″ washer) may be placed to ensure the rivet expands properly. A tool (not shown) is used so that by just pulling on the trigger it assures that the rivet has been properly mounted to the column at hole 132 (e.g., 0.390″ hole). There is no human requirement other then pulling the trigger. This rivet 102 has the following mechanical characteristics as compared with a bolt A490:

| | Rivet | Bolt A490 |
|---|---|---|
| Shear Strength | 15,950 lbs | 6,440 lbs |
| Tensile Strength | 10,250 lbs | 6,600 lbs |

Benefits of the blind rivet are a simpler, one man operation which minimizes human error. Also, the rivets are stronger than bolts and can be installed faster. And unlike a bolt, the rivet cannot back out so it is safer than bolt.

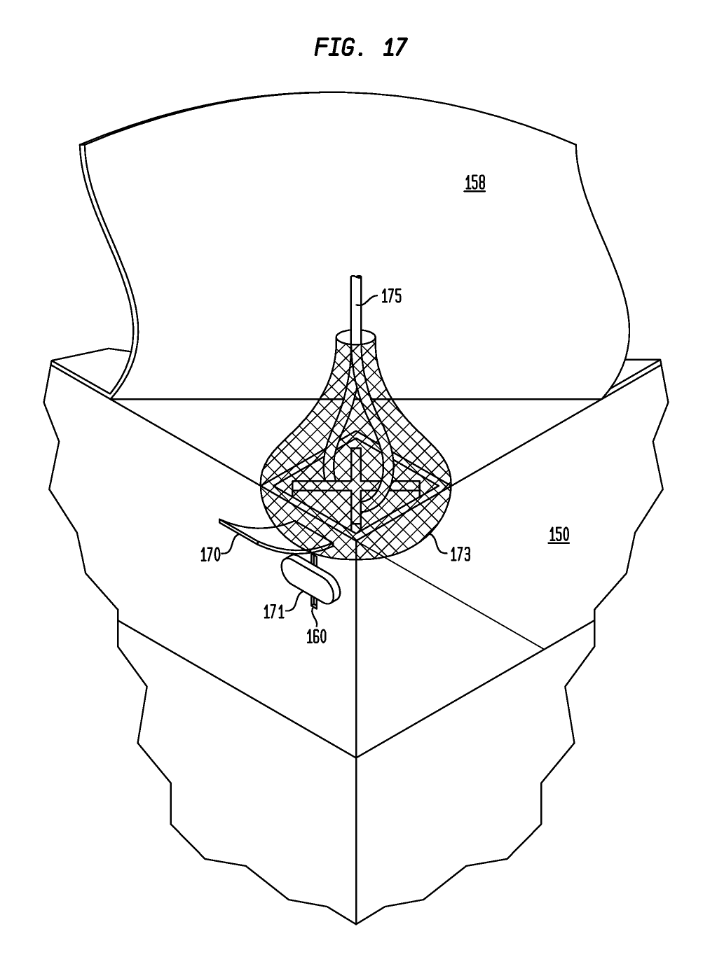

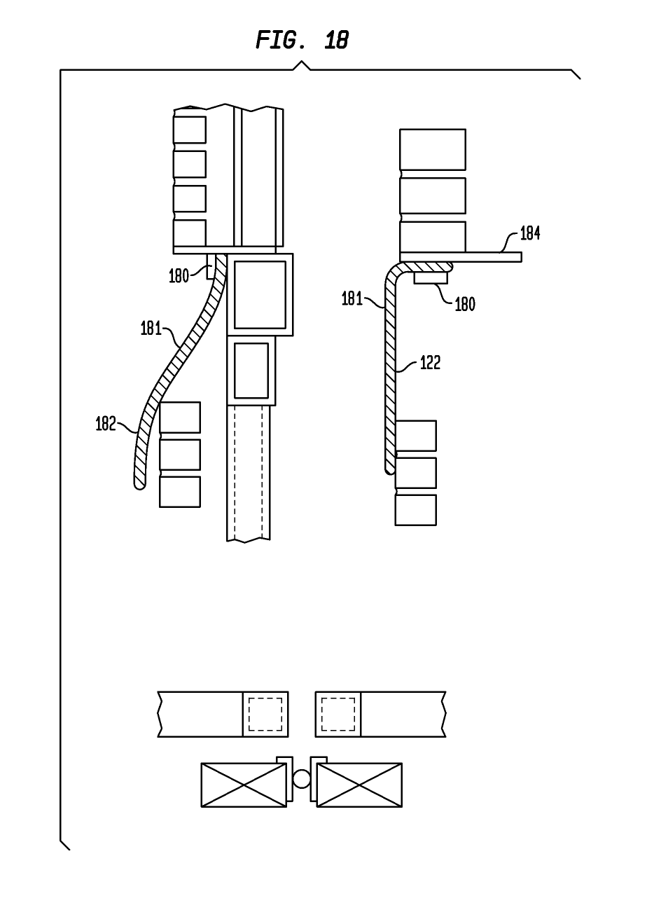

After the modules are constructed, the modules may sit offsite for storage. During this storage period, the module needs to be weatherproofed. As shown in FIGS. 15, 15a, 16 and 17, the module may be first wrapped with a light gage plastic sheet 150 such as Tyvek or equivalent strong enough not to rip during transportation and secondly is waterproof. Then the top of the modules is protected by using a sheet of rubber base 152 as EPDM or other and it overlaps the light gage plastic sheet 150. As shown in FIG. 15a. A skirt 154 may be provided to cover mate lines (not shown).

The rubber base may be strategically placed so as to locate positions for the lift points and air entry for air circulation. For example, an adhesive 154 may be laid in a corner of the structure so that a fold 158 may be made in the corner of the base layer 150. This fold may be pulled back to reveal the column and the adhesive will hold the rubber layer against the unit and only reveal the section of the unit needed for lifting. Additionally, Velcro may be adhered to the unit and the base layer so that the corners may be open and closed as needed.

Flaps and skirts may also be added to the unit for further protection. As shown in FIG. 17, a flap 170 may be adhered to the unit to protect the pin access slot 162. The top of the column may be provided with slits 160 for accessing pick points. A boot 173 may be provided on the lifting cable 175 for protecting the column. Skits 160 may be added to cover the access points for a lifting arm and access pick points.

Another weather protection aid is a magnetic skirt 181. A magnet 180 may be attached to metal flashing 184 of a unit. The magnet 180 is integral with a heavy duty plastic 182. This magnetic skirt covers exposed portions of the modular structure during construction and is easily attached and removed.

Benefits of this weather protection system are lower cost, lower labor, and the material does not need to be removed when setting the modules because it protects the module even when they are in place and set.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A truss for a modular structure comprising:
a base formed from two base girders and two base purlins;
a ceiling formed form two ceiling purlins and two ceiling girders; and
four columns, the four columns having a bottom portion and a top portion, the top portions attaching to the ceiling at the right angle portions and the bottom portion attaching to the base at the right angle portions, wherein a load path is carried by the four columns.

2. The truss of claim 1 wherein an effective depth of a beam is the height of the column.

3. A column for a modular structure comprising:
a lifting arm expanding a hollow portion of the column, wherein the lifting arm is used for lifting the modular structure.

4. The column of claim 3 wherein the lifting arm is a pin that tightly fits into a set of aligned holes on the column.

5. The column of claim 3 wherein the lifting arm is a pin that was formed integral with the column.

6. A method for lifting a modular structure having four hollow corner columns, the method comprising the steps of:
applying a lifting strap to a lifting arm expanding a hollow portion of each of the four columns; and
lifting the modular structure.

7. A column for a modular structure comprising:
a top, a bottom and four sides, the column having a hollow interior;
a tapered plug on the bottom of the column, wherein the tapered plug snaps fit into a hollow interior of a second column.

8. The column for a modular structure as claimed in claim 7 wherein the tapered plug is round.

9. The column for a modular structure as claimed in claim 8 wherein the tapered plug has a taper of approximately 30 degrees.

10. The column for a modular structure as claimed in claim 7 wherein the tapered plug is oval-shaped and prevents rotation of the column.

11. A method for assembling a modular high rise, the method comprising the steps of:
lifting a first section of the modular high rise;
aligning the first section with a second section;
setting a set of aligning plugs into receiving columns of the second modular structure;
fixing the first section to the second section.

12. The method for assembling a modular high rise of claim 11 wherein the set of plugs include one snap fit plug, one non-rotating plug and two floating plugs.

13. A method for covering a modular structure during a storage period, the method comprising the steps of:
covering the modular structure with a light gauge plastic;
covering the top of the modular structure with a sheet of rubber base; and
making a skirt on a bottom portion of the modular structure.
